(19) United States
(12) Patent Application Publication
(10) Pub. No.: US 2014/0120275 A1
(43) Pub. Date: May 1, 2014

(54) DISPLAY DEVICE

(71) Applicant: BOE TECHNOLOGY GROUP CO., LTD, Beijing (CN)

(72) Inventors: Shan Lu, Beijing (CN); Lu Zhao, Beijing (CN); Yanli Wang, Beijing (CN); Ken Wen, Beijing (CN)

(21) Appl. No.: 14/123,294

(22) PCT Filed: Nov. 13, 2012
(86) PCT No.: PCT/CN2012/084538

§ 371 Date: Dec. 2, 2013

(30) Foreign Application Priority Data
Apr. 25, 2011 (CN) 201210124532.7

(51) Int. Cl. G02F 1/1335

(52) U.S. Cl. CPC G02F 1/1336; G02F 1/133528
USPC 428/34.1

(57) ABSTRACT

The embodiments of the present invention disclose a display device comprising: a display panel for displaying images; and a support member for supporting the display panel, wherein the display panel and the support member are connected by a first connecting member therebetween. The embodiments of the present invention do not use an upper housing specifically for covering the top edges of a display device but use a support member to cover the lower end or side parts of the display device. Therefore the overall thickness of the display device is reduced, and the border width of the display device is also reduced, which makes the foreside of the display device appears as an integral structure, resulting in an esthetic appearance.

### TECHNICAL FIELD

The present invention relates to a display device, more particularly to a thin profile display device.

### BACKGROUND

In recent years, various panel display devices such as liquid crystal display devices (LCDs) have replaced the conventional cathode ray tubes (CRTs) and become popular display devices.

In addition to technical aspects of the panel displays, researches and developments are continuously conducted to realize display devices of light weight and thin profile design for satisfying customer requirements as much as possible.

However, a panel display device for display in prior art, such as a liquid crystal display device, has to employ an upper housing and a bottom housing with a liquid crystal panel and a backlight system disposed therebetween. Furthermore, in a liquid crystal display device in prior art, an outer case is additionally used to manufacture a notebook computer, a monitor, a TV set or a mobile equipment.

Since the upper housing, the bottom housing and the enclosure are inevitably used in the display device, the display device is limited in realizing light weight and thin profile.

Particularly, the upper edge of the liquid crystal display device panel is covered by the upper housing and the outer case, which not only increases the thickness of the liquid crystal display device, but also increases the edge width, i.e., the border width of the liquid crystal display device, endowing the display device a poor visual effect.

### SUMMARY

The embodiments of the present invention are intended to provide a display device capable of reducing an overall thickness of the display device and realizing a thin profile display device. The embodiments of the present invention further provide a display device which has a steady structure, is convenient for assembly, and possesses esthetic appearance.

An embodiment of the present invention provides a display device comprising: a display panel for displaying images; a support member for supporting the display panel, wherein the display panel and the support member are connected by a first connecting member therebetween.

In one embodiment, the support member comprises a flat plate section and a sidewall section extending upwardly from an end of the flat plate section; the flat plate section and the sidewall section form a housing space in which housed elements are housed.

In one embodiment, the first connecting member is glue or an adhesive tape.

In one embodiment, a top of the sidewall section and the display panel are connected by the first connecting member.

In one embodiment, the support member further comprises a sidewall top extending section and the display panel and the sidewall top extending section are connected by the first connecting member.

In one embodiment, the sidewall top extending section and the sidewall section are connected by a second connecting member.

In one embodiment, a part of the sidewall top extending section is disposed over the housing space for restricting movement of the housed elements in the housing space.

In one embodiment, the sidewall section comprises a sidewall partial surrounding section that partially surrounds the sidewall section, and the display panel is connected with the sidewall partial surrounding section by the first connecting member.

In one embodiment, the sidewall partial surrounding section and the sidewall section are connected by a third connecting member.

In one embodiment, the third connecting member comprises a protrusion formed on any one of the sidewall partial surrounding section and the sidewall section of the support member and an engaging groove for engaging the protrusion formed on other one of the sidewall partial surrounding section and the sidewall section of the support member.

In one embodiment, a part of the sidewall partial surrounding section is disposed over the housing space for restricting movement of the housed elements in the housing space.

In one embodiment, the display panel is a liquid crystal display panel, the liquid crystal display panel comprises an upper substrate, a lower substrate and polarizer sheets respectively disposed on the upper substrate and the lower substrate, and the polarizer sheets are not disposed in a region where the display panel is connected with the first connecting member.

In one embodiment, an inner sidewall of the sidewall section and the display panel are connected by the first connecting member.

In one embodiment, the sidewall section comprises a sidewall side extending section, wherein the sidewall side extending section and the sidewall section are connected by a fourth connecting member.

In one embodiment, the sidewall side extending section and the display panel is overlap-jointed or connected by the first connecting member.

In one embodiment, a part of the sidewall side extending section is disposed over the housing space for restricting movement of the housed elements in the housing space.

In one embodiment, the display panel is a liquid crystal display panel, the liquid crystal display panel comprises an upper substrate, a lower substrate and polarizer sheets formed on the upper substrate and the lower substrate, and the polarizer sheets are not disposed in a region where the sidewall side extending section joins the display panel.

In one embodiment, the sidewall section comprises a sidewall step, and the sidewall step and the display panel is overlap-jointed or connected by the first connecting member.

In one embodiment, the sidewall step and the sidewall section are an integral structure.

In one embodiment, the display panel is a liquid crystal display panel, the liquid crystal display panel comprises an upper substrate, a lower substrate and polarizer sheets formed on the upper substrate and the lower substrate, and the polarizer sheets are not disposed in a region where the sidewall step joins the display panel.

### BRIEF DESCRIPTION OF THE DRAWINGS

For better understanding technical proposals according to embodiments of the present invention, drawings of the embodiments will be described briefly below. Obviously, drawings in the following description only relate to some embodiments of the present invention, not to limit the present invention.

The drawings illustrate implementations of the present invention and serve to explain the principle of the present invention together with the description, in which:

FIG. 1 is a sectional view of the display device according to a first embodiment of the present invention;

FIG. 2 is a sectional view of the display device according to a second embodiment of the present invention;

FIG. 3 is a sectional view of the display device according to a third embodiment of the present invention;

FIGS. 4A and 4B are sectional views of the display devices according to a fourth and fifth implementations of the present invention;

FIG. 5 is a sectional view of the display device according to a sixth embodiment of the present invention;

FIG. 6 is a sectional view of the display device according to a seventh embodiment of the present invention;

FIG. 7 is a sectional view of the display device according to a eighth embodiment of the present invention; and

FIG. 8 shows a notebook computer that employs the display device according to the present invention.

### DETAILED DESCRIPTION

In order to make the purpose, technology solution and advantages of embodiments of the present invention more clear, technology solutions according to embodiments of the present invention will be described clearly and completely below with respect to drawings of embodiments of the present invention. It is to be understood that the described embodiments are part of but not all of embodiments of the present invention. Based on the described embodiments of the present invention, all other embodiments obtained by those of ordinary skill in the art without any creative labor fall into the protecting scope of the present invention. Same reference numerals are used to indicate same or similar parts throughout the drawings as far as possible.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at lease one. The terms “comprise,” “include,” etc., are intended to specify that the elements or the objects stated before these terms encompass the elements or the objects and equivalents thereof listed after these terms, but do not preclude the other elements or objects. The phrases “connect”, “join”, etc., are not intended to define a physical connection or mechanical connection, but may comprise an electrical connection, directly or indirectly. “On,” “under,” “right,” “left” and the like are only used to indicate relative position relationship, and when the position of the object which is described is changed, the relative position relationship may be changed accordingly. An embodiment of the present invention provides a display device comprising: a display panel for displaying images; a support member for supporting the display panel, wherein the display panel and the support member are connected through a first connecting member therebetween. The display panel may be a liquid crystal display panel (liquid crystal panel thereinafter), an organic light-emitting panel (OLED panel) or a plasma panel. The display device according to the embodiment of the present invention will be described below mainly by taking a liquid crystal display panel as an example of the display panel.

FIG. 8 is a stereogram showing a notebook computer 10 that employs the display device according to an embodiment of the present invention. FIGS. 1, 2, 3, 4A, 4B, 5, 6 and 7 are sectional views of corresponding display devices according to the embodiments of the present invention, which are sectional views along A-A of FIG. 8 respectively. While the present disclosure describes the embodiments of the present invention with respect to FIGS. 1, 2, 3, 4A, 4B, 5, 6 and 7, all concerned positional relationships refer to situations in which the display panel of the display device is disposed upward with respect to the horizontal plane.

Hereinafter, the display device according to a first embodiment of the present invention will be described with reference to the drawings.

FIG. 1 shows a sectional view of the display device according to the first embodiment of the present invention. As illustrated in FIG. 1, the display device according to the first embodiment of the present invention comprises a liquid crystal panel 100, a backlight system 300, a support member 300, and a first connecting member 400.

The support member 300 serves as an outer case and supports the liquid crystal panel. The liquid crystal panel 100 is located on the support member for displaying images. The backlight system 200 supplies light source for the liquid crystal panel.

The support member 300 serves as the outer case of a display device such as a notebook computer, a monitor or a TV set. Particularly, the support member 300 serves as a lower cover and a side cover of the display device. To this end, the support member 300 comprises a flat plate section 320 and a sidewall section 310 extending upwardly (for instance, vertically) from one end of the flat plate section and located under the liquid crystal panel 100.

When the flat plate section 320 and the sidewall section 310 are joined together, a predetermined housing space is formed inside the support member 300. Inside the housing space, disposed are housed elements which comprise the backlight system 200. The liquid crystal panel 100 is located on top of the sidewall section 310. The first connecting member 400 is used to connect the liquid crystal panel 100 and the top of the sidewall section 310. When the display panel is a self-luminescent display panel such as OLED panel, the housed element may not comprise the backlight source, and only comprises a printed circuit board and/or other elements.

More specifically, the liquid crystal panel 100 may comprise an upper substrate 120, a lower substrate 130, an upper polarizer 110 and a bottom polarizer 140.

The upper polarizer 110 is bonded to an upper surface of the upper substrate 120; and the bottom polarizer 140 is bonded to a bottom surface of the lower substrate 130.

A liquid crystal layer (not shown) is formed between the upper substrate 120 and the lower substrate 130. Specific structures of the upper substrate 120 and the lower substrate 130 may vary depending on the driving mode of the liquid crystal panel 100 such as a twist nematic (TN) mode, a vertical alignment (VA) mode, an in-plane switching (IPS) mode, and a Advanced Super Dimension Switch (ADS) mode that are well known by those skilled in the art.

The first connecting member 400 is provided to connect the support member 300 and the liquid crystal panel 100. More particularly, the first connecting member 400 is formed between the liquid crystal panel 100 and the top of sidewall section 310 of the support member 300 and therefore prevents the liquid crystal panel 100 from being separated upwardly. The first connecting member 400 may be glue or an adhesive tape such as double-side tape bonding member. Further, the bottom polarizer 140 of the liquid crystal panel 100 is not disposed in the region where the first connecting member 400 is connected with the liquid crystal panel 100. That is, only the first connecting member 400 is disposed between the lower substrate 130 of the liquid crystal panel 100 and the top of the sidewall section 310 of the support member 300 to thereby prevent possible increase in the thickness of the display device due to the addition of the first connecting member 400, realizing a lighter and thinner display device.

The backlight system 200 is roughly classified into a direct irradiation type and a side irradiation type. In case of the backlight system of the direct irradiation type, light sources are disposed on the entire bottom surface of the liquid crystal panel 100 so that light emitted from the light sources is directly transmitted to the liquid crystal panel 100. In case of the backlight system of the side irradiation type, a light source is disposed at an edge on bottom of the liquid crystal panel so that light emitted from the light source is transmitted through a light guiding plate to the liquid crystal panel 100. In embodiments of the present invention, both backlight systems of the direct irradiation type and the side irradiation type may be applied to the display device of the present invention.

In order to minimize the thickness of a display device, the display device may have for example a side irradiation type backlight system. Here, the display devices illustrated in all the drawings take one the side irradiation backlight system as an example of the backlight system.

The backlight system 200 comprises a light guiding plate 220 and a plurality of optical films 210.

Although not shown, a light source such as a light emitting diode or a fluorescent lamp is disposed on the side section facing the light guiding plate 220. After the light emitted from the light source is incident onto the light guiding plate 220, the path of the incident light is changed upward the liquid crystal panel 100. In order to modify the light path, various patterns are formed on the bottom surface of the light guiding plate 220.

The plurality of optical films 210 are disposed on the upper surface of the light guiding plate 220, and the plurality of optical films 210 are configured to make light incident on the liquid crystal panel 100 more uniform. The plurality of optical films may comprise an optical diffusion film and a prism film.

A reflective film (not shown) is formed on the bottom surface of the light guiding plate, and the reflective film can reflect light leaked at the bottom surface of the light guiding plate 220 upwardly back to the light guiding plate 220, thereby improving light utilization.

Although not shown, the housed elements may further comprise a printed circuit board.

As described above, since the sidewall section 310 of the support member 300 does not extend to the top of the liquid crystal panel 100, particularly no outer case and other fastener are formed on the upper edge of the liquid crystal panel 100, this structure can reduce the overall thickness of the display device of the embodiment of the present invention. Furthermore, the display device employing the above-mentioned structure has no framework, therefore the foreside of the display device appears as an integral structure visually, endowing an esthetic appearance for the display device.

A second embodiment of the present invention will be described in detail in the following.

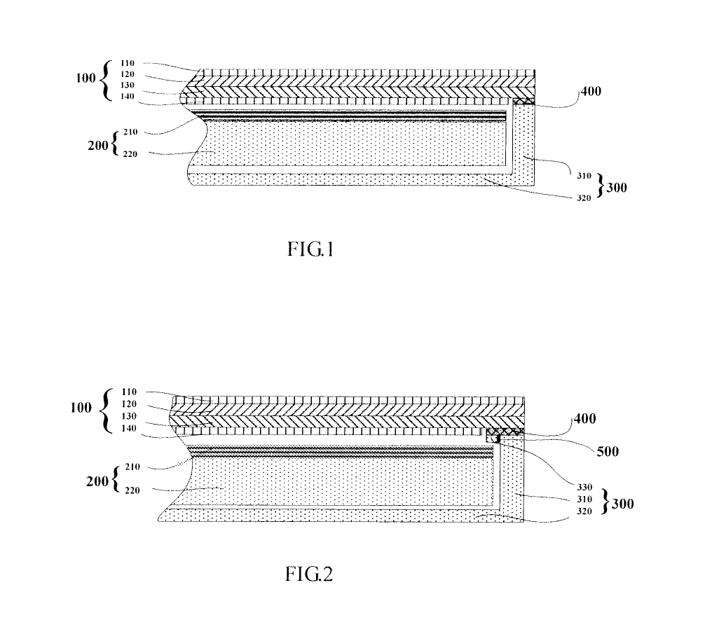

FIG. 2 is a sectional view of the display device according to the second embodiment of the present invention. As illustrated in FIG. 2, the display device according to the second embodiment of the present invention comprises a liquid crystal panel 100, a backlight system 300, a support member 300, a first connecting member 400 and a second connecting member 500.

Specifically, the liquid crystal panel 100 is configured to display images, the backlight system 200 is configured to supply light to the liquid crystal panel 100, and the support member 300 serves as an outer case and supports the liquid crystal panel. The support member 300 serves as the outer case of a display device such as a notebook computer, a monitor. Particularly, the support member 300 serves as a lower cover and a side cover of the display device. To this end, the support member 300 comprises a flat plate section 320, a sidewall section 310 extending upwardly (for instance, vertically) from one end of the flat plate section and located under the liquid crystal panel 100, and a sidewall top extending section 330. The sidewall top extending section 330 is located at an inner side of the sidewall section 310 and has an upper surface flush with the top of the sidewall section 310.

When the flat plate section 320 and the sidewall section 310 join each other, a predetermined housing space is formed inside the support member 300. Inside the housing space, disposed are housed elements that may comprise a backlight system 200, and may further comprise a printed circuit board (not shown). The liquid crystal panel 100 is located on top of the sidewall section 310. The first connecting member 400 is used to connect the liquid crystal panel 100 and the tops of the sidewall section 310 as well as the sidewall top extending section 330.

The second connecting member 500 is connected between the sidewall top extending section 330 and the sidewall section 310. The second connecting member 500 may be glue and an adhesive tape, and may also be a fastening means such as a bolt, a clincher, a block channel or a block button.

The first connecting member 400 is provided to connect the support member 300 and the liquid crystal panel 100. For example, the first connecting member 400 is formed between the liquid crystal panel 100 and the top of sidewall section 310 of the support member 300 and the upper surface of the sidewall top extending section 330 to thereby prevent the liquid crystal panel 100 from being separated upwardly. The first connecting member 400 may be glue or an adhesive tape such as a double-side tape bonding member. At the same time, the bottom polarizer 140 of the liquid crystal panel 100 is not formed in the region where the first connecting member 400 joins the liquid crystal panel 100. That is, only the first connecting member 400 is formed between the lower substrate 130 of the liquid crystal panel 100 and the top of the sidewall section 310 of the support member 300 as well as the upper surface of the sidewall top extending section 330 to thereby prevent possible increase in the thickness of the display device due to the addition of the first connecting member 400. Also, the existence of the sidewall top extending section 330 equivalently widens the sidewall section 310 of the support member, allowing the liquid crystal panel 100 to be more easily stuck on the sidewall section 310 of the support member 300 and establishing a more steady connection between the liquid crystal panel 100 and the support section 300.

Since the sidewall section 310 and the sidewall top extending section 330 in the support member 300 are separated structures, in assembling of the display device, it is possible to place the housed elements such as the backlight system 200 into the predetermined housing space first, and then connect the sidewall section 310 and the sidewall top extending section 330 to support the liquid crystal panel 100. Thus, disposing of the sidewall top extending section 330 will not influence assembling of the housed elements such as backlight system 200, which both satisfies the requirement for steady display system structure and the requirement for convenient loading and discharging.

In this embodiment, a partial region of the above-mentioned sidewall top extending section 330 is located over the housed elements for restricting movement of the housed elements in the housing space. As illustrated in FIG. 2, the sidewall section 310 of the sidewall top extending section 330 protrudes to one side of the housing space of the display device, and a partial region thereof can restrict the position of the housed elements in the housing space, which can not only ensure the system stability of the display device, but also avoid wearing of the housed elements due to severe rocking up and down in the housing space.

For instance, the specific structure of the liquid crystal panel 100 and the specific structure of the backlight system 200 are identical with that of the liquid crystal panel 100 and the backlight system 200 according to the first embodiment of the present invention. Detail description thereof will be omitted here.

As described above, since the sidewall section 310 of the support member 300 does not extend to the top of the liquid crystal panel 100, particularly no outer case and other fastener are formed on the upper edge of the liquid crystal panel 100, this structure can reduce the overall thickness of the display device according to the embodiment of the present invention. Furthermore, the display device employing the above-mentioned structure has no framework, and therefore the foreside of the display device appears as an integral structure visually, endowing an esthetic appearance for the display device. Furthermore, disposing of a sidewall top extending section 330 on the sidewall section 310 enlarges the bonding area between the liquid crystal panel 100 and the support section 300, and further enhances supporting of the liquid crystal panel 100 by the support member 300, and enhancing the stability of the above-mentioned structure.

A third, fourth and fifth implementations of the present invention will be described in detail in the following.

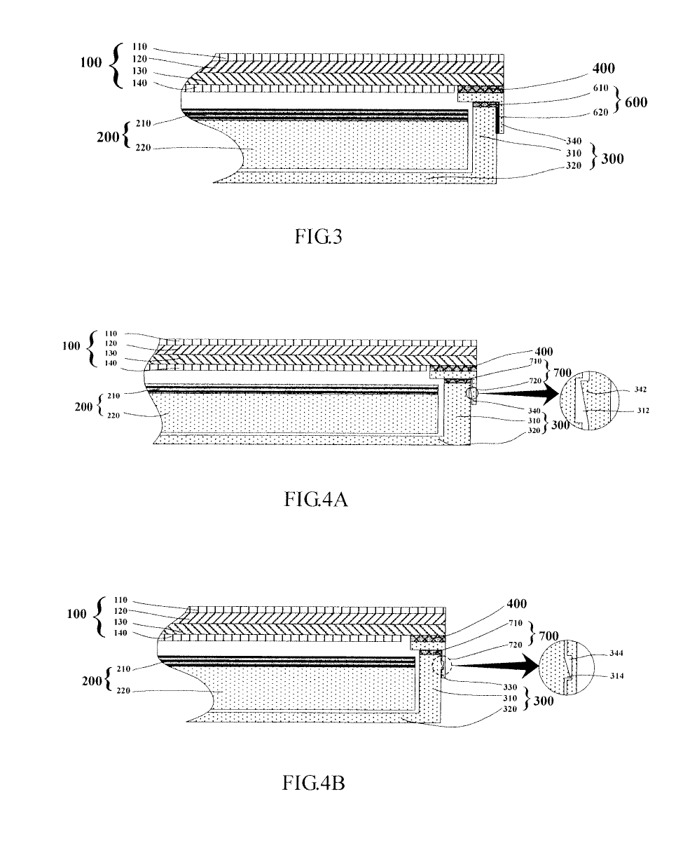

FIG. 3 is a sectional view of the display device according to the third embodiment of the present invention. As illustrated in FIG. 3, the display device according to the third embodiment of the present invention comprises a liquid crystal panel 100, a backlight system 300, a support member 300, a first connecting member 400, and a third connecting member 600.

Specifically, the liquid crystal panel 100 is configured to display images, the backlight system 200 is configured to supply light to the liquid crystal panel 100, and the support member 300 serves as an outer case and supports the liquid crystal panel. The support member 300 serves as an outer case of a display device such as a notebook computer, a monitor. Particularly, the support member 300 serves as a lower cover and a side cover of the display device. To this end, the support member 300 comprises a flat plate section 320, a sidewall section 310 extending upwardly (for instance, vertically) from one end of the flat plate section and located under the liquid crystal panel 100, and a sidewall partial surrounding section 340. The sidewall partial surrounding section 340 comprises horizontal and vertical two parts connected together, in which the vertical part is located outside of the sidewall section 310 and the horizontal part is located on top of the sidewall section 310.

When the flat plate section 320 and the sidewall section 310 join each other, a predetermined housing space is formed inside the support member 300. Inside the housing space, disposed are housed elements that comprise the backlight system 200, and may further comprise a printed circuit board (not shown). The sidewall partial surrounding section 340 is disposed on top of the sidewall section 310, and the liquid crystal panel 100 is located on top of the sidewall partial surrounding section 340. The first connecting member 400 is used to connect the liquid crystal panel 100 and the top of the sidewall partial surrounding section 340.

The sidewall partial surrounding section 340 and the sidewall section 310 are secured by the third connecting member 600. Tops of the sidewall partial surrounding section 340 and the sidewall section 310 are connected by a support member connecting member 610 in the third connecting member 600 that may be glue or an adhesive tape. Outer lateral parts of the sidewall partial surrounding section 340 and the sidewall section 310 are connected by a support member connecting member 620 in the third connecting member 600 that may be glue or an adhesive tape and also may be a fastening means such as a bolt, a clincher, a block channel or a block button.

The first connecting member 400 is provided to connect the support member 300 and the liquid crystal panel 100. For instance, the first connecting member 400 is formed between the liquid crystal panel 100 and the upper surface of the sidewall partial surrounding section 340 to thereby prevent the liquid crystal panel 100 from being separated upwardly. The first connecting member 400 may be glue or an adhesive tape such as a double-side tape bonding member. At the same time, the bottom polarizer 140 of the liquid crystal panel 100 is not formed in the region where the first connecting member 400 joins the liquid crystal panel 100. That is, only the first connecting member 400 is formed between the lower substrate 130 of the liquid crystal panel 100 and the upper surface of the sidewall partial surrounding section 340 to thereby prevent possible increase in the thickness of the display device due to the addition of the first connecting member 400.

Since the sidewall section 310 and the sidewall partial surrounding section 340 in the support member 300 are separated structures, in assembling of the display device, it is possible to place housed elements such as backlight system 200 into the predetermined housing space first, and then connect the sidewall section 310 and the sidewall partial surrounding section 340 to support the liquid crystal panel 100. Thus, disposing the sidewall partial surrounding section 340 will not influence assembling of housed elements such as backlight system 200. Further, the width configuration of the sidewall partial surrounding section 340 may be properly increased to increase contact area between the support member 300 and the liquid crystal panel 100, thereby enhancing connection stability between the support member 300 and the liquid crystal panel 100. This display device structure can not only enhance structure stability of the display system, but also satisfy requirements for convenient loading and unloading.

For instance, the specific structure of the liquid crystal panel 100 and the specific structure of the backlight system 200 are identical with that of the liquid crystal panel 100 and the backlight system 200 according to the first embodiment of the present invention. Detail description thereof will be omitted here.

As described above, since the sidewall section 310 of the support member 300 does not extend to the top of the liquid crystal panel 100, particularly no outer case and other fastener are formed on the upper edge of the liquid crystal panel 100, this structure can reduce the overall thickness of the display device according to the embodiment of the present invention. Furthermore, the display device employing the above-mentioned structure has no framework, and therefore the foreside of the display device appears as an integral structure visually, endowing an esthetic appearance for the display device. Furthermore, additionally disposing of a sidewall partial surrounding section 340 between the sidewall section 310 and the liquid crystal panel 100 enlarges the bonding area between the liquid crystal panel 100 and the support section 300, and further enhances supporting of the liquid crystal panel 100 by the support member 300, and enhancing the stability of the above-mentioned structure.

FIGS. 4A and 4B are sectional views of the display devices according to the fourth and fifth implementations of the present invention.

Except for the exterior connection manner between the sidewall partial surrounding section 340 and the sidewall section 310, the display devices according to the fourth and fifth implementations of the present invention are basically the same as that of the third embodiment of the present invention illustrated in FIG. 3 in terms of their structures. That is, the sidewall partial surrounding section 340 is connected with the liquid crystal panel 100 by the first connecting member 400, connected with the sidewall section 310 by the second connecting member 700, and the second connecting member 700 comprises a first part 710 for connecting the sidewall partial surrounding section 340 and the top of the sidewall section 310 and a second part 720 for connecting the sidewall partial surrounding section 340 and the exterior lateral part of the sidewall section 310. Therefore, throughout the drawings, same reference numerals will be used to indicate same or similar parts and detail description of same parts will be omitted. Among others, the first part 710 may be the same as or similar to the support member connecting member 620 in previous embodiments.

As illustrated in FIG. 4A, according to the fourth embodiment of the present invention, the second part 720 of the second connecting member 700 comprises a protrusion 342 formed at an inner side of the sidewall partial surrounding section 340 of the support member 300 and an engaging groove 312 for engaging the protrusion 342 formed on a sidewall section 310 of the support member 300, thereby steadily connecting the sidewall section 310 and the sidewall partial surrounding section 340 of the support member 300 with each other with the engagement of the protrusion 342 and the engaging groove 312.

As illustrated in FIG. 4B, according to the fifth embodiment of the present invention, a protrusion 314 is formed at an outer side of the sidewall section 310 of the support member 300, and an engaging groove 344 for engaging the protrusion 314 is formed on the sidewall partial surrounding section 340 of the support member 300, thereby steadily connecting the sidewall section 310 and the sidewall partial surrounding section 340 of the support member 300 with the engagement of the protrusion 314 and the engaging groove 344.

In the above-mentioned third, fourth and fifth embodiments, a partial structure of the sidewall partial surrounding section 340 is further configured to restrict the position of the housed elements. As illustrated in FIGS. 3, 4A and 4B, the horizontal part of the sidewall partial surrounding section 340 has a width wider than that of the sidewall section 310, making a part of the sidewall partial surrounding section 340 to be over the housing space of the display device, which restricts movements of the housed elements in the housing space. This can not only ensure the system stability of the display device, but also avoid wearing of the housed elements due to severe rocking up and down in the housing space.

A sixth embodiment of the present invention will be described in detail in the following.

FIG. 5 is a sectional view of the display device according to the sixth embodiment of the present invention. As illustrated in FIG. 5, the display device according to the sixth embodiment of the present invention comprises a liquid crystal panel 100, a backlight system 300, a support member 300, and a first connecting member 400.

Specifically, the liquid crystal panel 100 is configured to display images, the backlight system 200 is configured to supply light to the liquid crystal panel 100, and the support member 300 serves as an outer case and supports the liquid crystal panel. The support member 300 serves as an outer case of a display device such as a notebook computer, a monitor. Particularly, the support member 300 serves as a lower cover and a side cover of the display device. To this end, the support member 300 comprises a flat plate section 320 and a sidewall section 310 extending upwardly (for instance, vertically) from one end of the flat plate section and located under the liquid crystal panel 100.

When the flat plate section 320 and the sidewall section 310 join each other, a predetermined housing space is formed inside the support member 300. Inside the housing space, disposed are housed elements that comprise the backlight system 200 and may further comprise a printed circuit board (not shown). The first connecting member 400 is used to connect the sides of the liquid crystal panel 100 and inner side parts of the sidewall section 310.

The first connecting member 400 is provided to connect the support member 300 and the liquid crystal panel 100. The first connecting member 400 is formed between the sides of the liquid crystal panel 100 and the inner sidewalls of sidewall section 310 of the support member 300 to thereby prevent the liquid crystal panel 100 from being separated upwardly. The first connecting member 400 may be glue or an adhesive tape such as a double-side tape bonding member.

The specific structure of the liquid crystal panel 100 and the specific structure of the backlight system 200 are identical with that of the liquid crystal panel 100 and the backlight system 200 according to the first embodiment of the present invention. Detail description thereof will be omitted here.

As described above, since the sidewall section 310 of the support member 300 does not extend to the top of the liquid crystal panel 100, particularly no outer case and other fastener are formed on the upper edge of the liquid crystal panel 100, this structure can reduce the overall thickness of the display device according to the embodiment of the present invention. Furthermore, the display device employing the above-mentioned structure has no framework, and therefore the foreside of the display device appears as an integral structure visually, endowing an esthetic appearance for the display device.

A seventh embodiment of the present invention will be described in detail in the following.

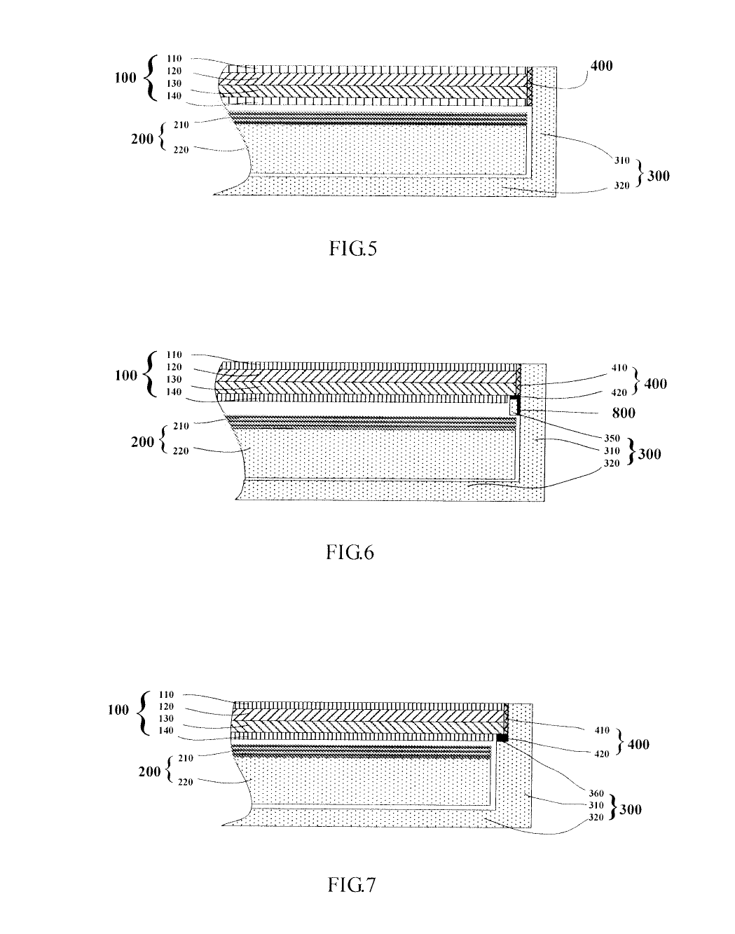

FIG. 6 is a sectional view of the display device according to the seventh embodiment of the present invention. As illustrated in FIG. 6, the display device according to the seventh embodiment of the present invention comprises a liquid crystal panel 100, a backlight system 300, a support member 300, a first connecting member 400, and a fourth connecting member 800.

Specifically, the liquid crystal panel 100 is configured to display images, the backlight system 200 is configured to supply light to the liquid crystal panel 100, and the support member 300 serves as an outer case and supports the liquid crystal panel. The support member 300 serves as an outer case of a display device such as a notebook computer, a monitor. Particularly, the support member 300 serves as a lower cover and a side cover of the display device. To this end, the support member 300 comprises a flat plate section 320, a sidewall section 310 extending upwardly (for instance, vertically) from one end of the flat plate section and located under the liquid crystal panel 100, and a sidewall side extending section 350. The sidewall side extending section 350 is disposed on an inner sidewall of the sidewall section 310 to support the liquid crystal panel 100.

When the flat plate section 320 and the sidewall section 310 join each other, a predetermined housing space is formed inside the support member 300. Inside the housing space, disposed are housed elements that comprise the backlight system 200, and may further comprise a printed circuit board (not shown). A first part 410 in the first connecting member 400 is used to connect a side of the liquid crystal panel 100 and the inner side part of the sidewall section 310.

The sidewall side extending section 350 and the sidewall section 310 are connected by the fourth connecting member 800. The fourth connecting member 800 may be glue and an adhesive tape, and may also be a fastening means such as a bolt, a clincher, a block channel or a block button.

The first connecting member 400 is provided to connect the support member 300 and the liquid crystal panel 100. For example, the liquid crystal panel 100 is located on the sidewall side extending section 350, and the first part 410 of the first connecting member 400 is formed between it and an inner side part of the sidewall section 310 of the support member 300 to thereby prevent the liquid crystal panel 100 from being separated upwardly. The first connecting member 400 may be glue or an adhesive tape such as a double-side tape bonding member. At this point, the first connecting member 400 may also be located between the sidewall side extending section 350 and the liquid crystal panel 100, that is, the sidewall side extending section 350 and the liquid crystal panel 100 are connected by the second part 420 of the first connecting member 400. Furthermore, the sidewall side extending section 350 and the liquid crystal panel 100 may be simply overlap-jointed.

When the sidewall side extending section 350 and the liquid crystal panel 100 are connected by the first connecting member 400, the bottom polarizer 140 of the liquid crystal panel 100 is not provided in regions of the sidewall side extending section 350 of the support member 300 adjacent to the liquid crystal panel 100. That is, only the first connecting member 400 is disposed between the lower substrate 130 of the liquid crystal panel 100 and the upper surface of the sidewall side extending section 350 to thereby prevent possible increase in the thickness of the display device due to the addition of the first connecting member 400. Also, the existence of the sidewall side extending section 350 equivalently widens the sidewall section 310 of the support member 300, allowing the liquid crystal panel 100 to be fixed on the sidewall section 310 of the support member 300 more easily.

Since the sidewall section 310 and the sidewall side extending section 350 in the support member 300 are separated structures, in assembling of the display device, it is possible to place the housed elements such as the backlight system 200 into the predetermined housing space first, and then connect the sidewall section 310 and the sidewall side extending section 350 to support the liquid crystal panel 100. Thus, disposing of the sidewall side extending section 350 will not influence assembling of the housed elements such as the backlight system 200. Further, the width configuration of the sidewall side extending section 350 may be properly increased to increase contact area between the support member 300 and the liquid crystal panel 100, thereby enhancing connection stability between the support member 300 and the liquid crystal panel 100.

In this embodiment, partial region of the above-mentioned sidewall side extending section 350 is further configured to restrict the positions of the housed elements. As illustrated in FIG. 6, the sidewall side extending section 350 protrudes to one side of the housing space of the display device from the sidewall section 310, and thus can not only support the liquid crystal panel 100 located thereon, but also restrict movement of the underlying housed elements in the housing space, and also not only ensure the system stability of the display device, but also avoid wearing of the housed elements due to severe rocking up and down in the housing space.

More particularly, the specific structure of the liquid crystal panel 100 and the specific structure of the backlight system 200 are identical with that of the liquid crystal panel 100 and the backlight system 200 according to the first embodiment of the present invention. Detail description thereof will be omitted here.

As described above, since the sidewall section 310 of the support member 300 does not extend to the top of the liquid crystal panel 100, particularly no outer case and other fastener are formed on the upper edge of the liquid crystal panel 100, this structure can reduce the overall thickness of the display device according to the embodiment of the present invention. Furthermore, the display device employing the above-mentioned structure has no framework, and therefore the foreside of the display device appears as an integral structure visually, endowing an esthetic appearance for the display device. Furthermore, since a sidewall side extending section 350 is added at the inner side of the sidewall section 310, it can support the liquid crystal panel from below, allowing the liquid crystal panel 100 to be mounted on the sidewall section 310 of the support member more easily.

A eighth embodiment of the present invention will be described in detail in the following.

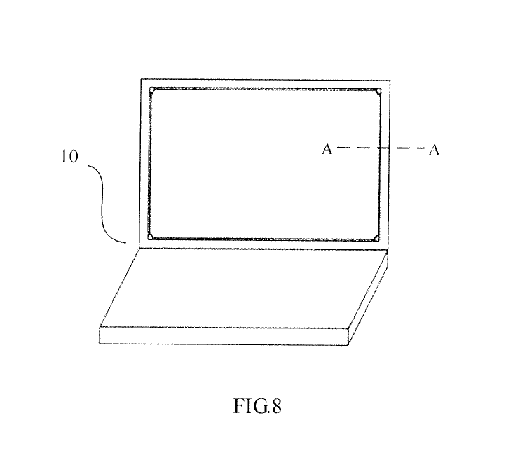

FIG. 7 is a sectional view of the display device according to the eighth embodiment of the present invention. As illustrated in FIG. 7, the display device according to the eighth embodiment of the present invention comprises a liquid crystal panel 100, a backlight system 300, a support member 300, and a first connecting member 400.

Specifically, the liquid crystal panel 100 is configured to display images, the backlight system 200 is configured to supply light to the liquid crystal panel 100, and the support member 300 serves as an outer case and supports the liquid crystal panel. The support member 300 serves as an outer case of a display device such as a notebook computer, a monitor. Particularly, the support member 300 serves as a lower cover and a side cover of the display device. To this end, the support member 300 comprises a flat plate section 320, a sidewall section 310 extending upwardly (for instance, vertically) from one end of the flat plate section and located under the liquid crystal panel 100, and a sidewall step 360. The sidewall step 360 is located at the inner side of the sidewall section 310 with a height smaller than that of the sidewall section 310 to support the liquid crystal panel 100.

When the flat plate section 320 and the sidewall section 310 join each other, a predetermined housing space is formed inside the support member 300. Inside the housing space, disposed are housed elements that comprise the backlight system 200 and may further comprise a printed circuit board (not shown). The first connecting member 400 is used to connect sides of the liquid crystal panel 100 and inner side parts of the sidewall section 310.

The sidewall step 360 is integral with the sidewall section 310.

The first connecting member 400 is provided to connect the support member 300 and the liquid crystal panel 100. More particularly, the liquid crystal panel 100 is located on the sidewall step 360, and a first part 410 of the first connecting member 400 is formed between it and an inner side part of the sidewall section 310 of the support member 300 to thereby prevent the liquid crystal panel 100 from being separated upwardly. The first connecting member 400 may be glue or an adhesive tape such as a double-side tape bonding member. At this point, the first connecting member 400 may be located between the sidewall step 360 and the liquid crystal panel 100, that is, the sidewall step 360 and the liquid crystal panel 100 are connected by a second part 420 of the first connecting member 400. Furthermore, the sidewall step 360 and the liquid crystal panel 100 may also be simply overlap-jointed therebetween.

At the same time, when the first connecting member 420 is glue or an adhesive tape, the bottom polarizer 140 of the liquid crystal panel 100 is not formed in the region where the sidewall step 360 of the support member 300 joins the liquid crystal panel 100. That is, only the first connecting member 420 is formed between the lower substrate 130 of the liquid crystal panel 100 and the upper surface of the sidewall step 360 to thereby prevent possible increase in the thickness of the display device due to the addition of the first connecting member 420. Also, the existence of the sidewall step 360 widens the sidewall section 310 of the support member 300, allowing the liquid crystal panel 100 to be fixed on the sidewall section 310 of the support member 300 more easily.

More particularly, the specific structure of the liquid crystal panel 100 and the specific structure of the backlight system 200 are identical with that of the liquid crystal panel 100 and the backlight system 200 according to the first embodiment of the present invention. Detail description thereof will be omitted here.

As described above, since the sidewall section 310 of the support member 300 does not extend to the top of the liquid crystal panel 100, particularly no outer case and other fastener are formed on the upper edge of the liquid crystal panel 100, this structure can reduce the overall thickness of the display device according to the embodiment of the present invention. Furthermore, the display device employing the above-mentioned structure has no framework, and therefore the foreside of the display device appears as an integral structure visually, endowing an esthetic appearance for the display device. Furthermore, since a sidewall step 360 is added at the inner side of the sidewall section 310, it can support the liquid crystal panel from below, allowing the liquid crystal panel 100 to be mounted on the sidewall section 310 of the support member 300 more easily.

What have been described above relate to liquid crystal display devices among various kinds of display devices, but the limitation is not necessary. In addition to the liquid crystal display device, the configuration may also be applied to display devices such as organic light-emitting devices. In case of organic light-emitting devices, a predetermined housing space is formed in the support member in which the housed elements not comprising a backlight system 200 are housed.

In the first to eighth implementations of the present invention, there may also be a heat dissipation section between the flat plate section 320 and the backlight system 200 to evenly transmit and dissipate heat generated by the backlight system to outside.

As the increase of the sizes of display devices, heat generated from the backlight system 200 increases as well, a heat dissipation section needs to be provided to dissipate heat generated by the backlight system 200.

When the embodiments of the present invention are applied to equipments of small sizes such as notebook computers, i.e., equipments generating less heat, there may be not provided the heat dissipation sections. When the embodiments of the present invention are applied to equipments with large sizes such as monitors or TV sets, i.e., equipments generating more heat, there may be provided the heat dissipation sections.

The above are only exemplary implementations of the present invention, rather than for limiting protection scope of the present invention, which is defined by the appended claims.

1. A display device, comprising:
a display panel for displaying images; and
a support member for supporting the display panel,
wherein the display panel and the support member are connected by a first connecting member therebetween.

2. The display device of claim 1, wherein the support member comprises a flat plate section and a sidewall section extending upwardly from an end of the flat plate section; the flat plate section and the sidewall section form a housing space in which housed elements are housed.

3. The display device of claim 1, wherein the first connecting member is glue or an adhesive tape.

4. The display device of claim 2, wherein a top of the sidewall section and the display panel are connected by the first connecting member.

5. The display device of claim 2, wherein the support member further comprises a sidewall top extending section, and the display panel and the sidewall top extending section are connected by the first connecting member.

6. The display device of claim 5, wherein the sidewall top extending section and the sidewall section are connected by a second connecting member.

7. The display device of claim 5, wherein a part of the sidewall top extending section is disposed over the housing space for restricting movement of the housed elements in the housing space.

8. The display device of claim 2, wherein the sidewall section comprises a sidewall partial surrounding section that partially surrounds the sidewall section, and the display panel is connected with the sidewall partial surrounding section by the first connecting member.

9. The display device of claim 8, wherein the sidewall partial surrounding section and the sidewall section are connected by a third connecting member.

10. The display device of claim 9, wherein the third connecting member comprises a protrusion formed on any one of the sidewall partial surrounding section and the sidewall section of the support member and an engaging groove, for engaging the protrusion, formed on other one of the sidewall partial surrounding section and the sidewall section of the support member.

11. The display device of claim 8, wherein a part of the sidewall partial surrounding section is disposed over the housing space for restricting movement of the housed elements in the housing space.

12. The display device of claim 1, wherein the display panel is a liquid crystal display panel, the liquid crystal display panel comprises an upper substrate, a lower substrate and polarizer sheets respectively disposed on the upper substrate and the lower substrate, and the polarizer sheets are not disposed in a region where the display panel is connected with the first connecting member.

13. The display device of claim 2, wherein an inner sidewall of the sidewall section and the display panel are connected by the first connecting member.

14. The display device of claim 13, wherein the sidewall section comprises a sidewall side extending section, wherein the sidewall side extending section and the sidewall section are connected by a fourth connecting member.

15. The display device of claim 14, wherein the sidewall side extending section and the display panel is overlap-jointed or connected by the first connecting member.

16. The display device of claim 13, wherein a part of the sidewall side extending section is disposed over the housing space for restricting movement of the housed elements in the housing space.

17. The display device of claim 16, wherein the display panel is a liquid crystal display panel, the liquid crystal display panel comprises an upper substrate, a lower substrate and polarizer sheets formed on the upper substrate and the lower substrate, and the polarizer sheets are not disposed in a region where the sidewall side extending section joins the display panel.

18. The display device of claim 13, wherein the sidewall section comprises a sidewall step, and the sidewall step and the display panel is overlap-jointed or connected by the first connecting member.

19. The display device of claim 18, wherein the sidewall step and the sidewall section are an integral structure.

20. The display device of claim 18, wherein the display panel is a liquid crystal display panel, the liquid crystal display panel comprises an upper substrate, a lower substrate and polarizer sheets formed on the upper substrate and the lower substrate, and the polarizer sheets are not disposed in a region where the sidewall step joins the display panel.
